(19) United States
(12) Patent Application Publication
(10) Pub. No.: US 2020/0273037 A1
(43) Pub. Date: Aug. 27, 2020

(54) PAYMENT-SYSTEM-BASED USER AUTHENTICATION AND INFORMATION ACCESS SYSTEM AND METHODS

(71) Applicant: MASTERCARD INTERNATIONAL INCORPORATED, Purchase, NY (US)

(72) Inventors: Simon Phillips, York (GB); Alan Johnson, Essex (GB); Jorn Lambert, London (GB)

(21) Appl. No.: 16/281,495

(22) Filed: Feb. 21, 2019

(51) Int. Cl. G06Q 20/40; G06Q 20/32; G06Q 20/34; G06F 21/62

(52) U.S. Cl. CPC G06Q 20/4014; G06Q 20/3223; G06Q 20/204; G06F 21/6245; G06Q 20/341

(57) ABSTRACT

A null-amount payment account system transaction is performed in cooperation with a user payment device presented by a user. In response to successful completion of the transaction, a download of data is received regarding the user.

### BACKGROUND

FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee thereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; (b) tracking and storing transactions and maintaining account records; (c) rendering periodic account statements; and (d) receiving and tracking payments to the issuer from the account holders.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

Still further, and as is well-known, for e-commerce transactions, an e-commerce server computer (not shown) may function as the POS terminal. The e-commerce server computer may be operated by or on behalf of a merchant and may be accessed by the account holder via a browser program running on (for example) a personal computer (not shown) or a smartphone (not shown apart from payment device 102). To arrange for the payment portion of the e-commerce transaction, the account holder may manually enter a payment account number, or authorize a charge from a payment account number held on file by the merchant, or access a digital wallet, etc.

The present inventors have now recognized that there are opportunities to utilize security capabilities built-in to conventional payment systems in a novel way to facilitate and control selective and secure dissemination of information related to users of payment accounts.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram that illustrates a conventional payment system.

FIG. 2 is a block diagram that illustrates an embodiment of an information dissemination system provided according to aspects of the present disclosure.

FIG. 3 is a block diagram of a payment system that also has information dissemination functionality according to aspects of the present disclosure.

FIG. 4 is a block diagram that illustrates a computer system that may be a component of the information dissemination system of FIG. 2.

FIG. 5 is a simplified block diagram illustration of a mobile device that may be used in the information dissemination system of FIG. 2.

FIG. 6 is a simplified block diagram of a user authentication terminal that may be a component of the information dissemination system of FIG. 2.

FIG. 7 is a flow chart that illustrates a process that may be performed according to aspects of the present disclosure in the information dissemination system of FIG. 2.

### DESCRIPTION

In general, and for the purpose of introducing concepts of embodiments of the present disclosure, a user is asked to perform a zero-monetary-amount transaction or other transaction in accordance with practices of a payment card account system. (A zero-monetary amount transaction may sometimes hereinafter be referred to as a “null-amount” transaction.) The user may employ a payment device such as, for example, a payment-enabled mobile device to engage in the requested transaction via interaction between the payment device and a terminal operated by an entity that wishes to receive information pertaining to the user. As part of the transaction the payment device may generate a cryptogram or other security-related data item and may transmit the cryptogram or data item to the terminal. The payment device may also transmit to the terminal a payment account number or payment token that identifies the user. Upon completion of the terminal/payment device phase of the transaction, the terminal may generate an information request and transmit the information request to a remote data storage/dissemination computer. It is to be understood that the desired information pertaining to the user was previously stored in the remote computer. The information request may include the cryptogram/security data as well as the payment account number/token, and may also identify the entity that is seeking the user information. The remote computer may look up the user in its records, and upon verifying the cryptogram/security data, may then download to the terminal the desired information pertaining to the user. The terminal may then store the data in a local data store operated by the entity that operates the terminal and that desired to obtain the information pertinent to the user.

With an arrangement of this kind, a user may conveniently arrange to have his/her information disseminated to an entity with which the user is engaging, and in such a manner that security features characteristic of payment card account transactions operate to secure the information dissemination in a manner that protects both the user and the entity that receives the user information.

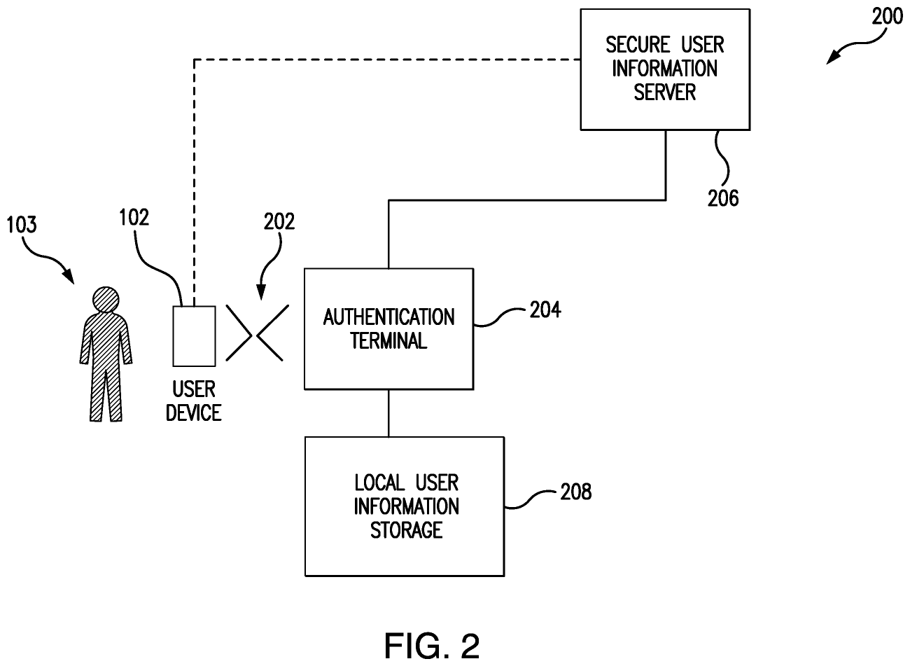

FIG. 2 is a block diagram that illustrates an embodiment of an information dissemination system 200 provided according to aspects of the present disclosure.

FIG. 2 shows a user 103 operating a payment device 102 (e.g., a suitably programmed smartphone). In some embodiments, the payment device need not be specially programmed to enable operation with the information dissemination system 200, but rather may be programmed/provisioned in a conventional manner for engaging in payment card account system transactions. At 202, the payment device 102 is shown interacting with a user authentication terminal 204. In some use cases, the interaction between the user authentication terminal 204 and the payment device 102 may be of a nature to emulate a null-amount payment card account system transaction. In some embodiments, the transaction may be performed in accordance with an EMV (Europay-Mastercard-Visa) transaction standard. (Those who are skilled in the art are familiar with EMV transactions.) As part of the transaction, the payment device 102 may generate a cryptogram and may transmit the cryptogram to the user authentication terminal 204. The payment device 102 may also transmit a payment account number or payment token to the user authentication terminal 204, for the purpose of identifying the user 103.

In addition to the user authentication terminal 204, the information dissemination system 200 may also include a remote user information server computer 206. The remote user information server computer 206 may store information entrusted thereto for storage and dissemination to trusted parties by numerous users, including the user 103. Numerous organizations, merchants, etc. may have registered with the remote user information server computer 206 as trusted parties suitable to receive user information that they request from time to time. The remote user information server computer 206 may receive an information request from the user authentication terminal 204 in connection with the transaction that occurred between the user authentication terminal 204 and the payment device 102. This may take place immediately after the terminal/payment device transaction occurs. The information request may include the user's payment account number or token and the cryptogram generated by the payment device 102 and transmitted by the payment device 102 to the user authentication terminal 204.

The remote user information server computer 206 may look up the data record for the user 103 by using the payment account number/token and may verify the cryptogram. With the user thus identified and authenticated, the remote user information server computer 206 may then release information pertaining to the user by transmitting such information to the user authentication terminal 204. This assumes that prior consent to release of information in such cases has been given to the remote user information server computer 206 by the user 103. In some embodiments, the user 103 may have specified the types of information to be released by the remote user information server computer 206, possibly depending on what type of entity is to receive the information. In some use cases, the remote user information server computer 206 communicates with the user 103 (e.g., via the payment device 102) to obtain confirmation that the user wishes the requesting entity to receive the requested information.

The information dissemination system 200 may also include a local user information storage device 208, connected to the user authentication terminal 204, to receive and store user information obtained by the user authentication terminal 204 from the remote user information server computer 206. In some embodiments, the local user information storage device 208 may be a suitably programmed server computer, or data storage assets in the “cloud” available for access by the entity that operates the user authentication terminal 204. In some embodiments, the local user information storage device 208 may be at least partially integrated with the user authentication terminal 204.

To describe, at this point, just one use case as an example, let it be assumed that the transaction 202 occurs at a hospital (or other medical provider), which operates the user authentication terminal 204. The transaction 202 occurs as the user 103 checks in to the hospital as a patient, and the requested information may include the user's name, address, date of birth, health insurance information, and/or other information suitable to facilitate the hospital's intake of the user as a patient. Through machine authentication of the user's identity and downloading automatically of (at least some) patient intake information, the process may take place securely and rapidly, and at least partially free of handwritten or keyboarded patient data entry; this may tend to reduce mistakes in data entry and save time for the user 103 and the hospital. The entire transaction and automatic downloading and storage of patient information may occur rapidly, say within 60 seconds or less.

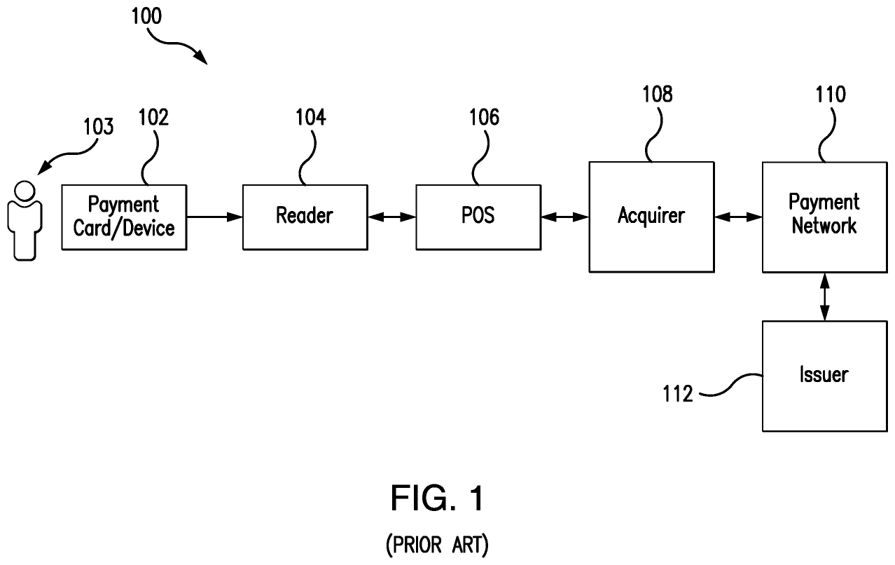

FIG. 2 depicts components of the information dissemination system 200 that are involved in a single authentication transaction/information request. In a practical embodiment of the information dissemination system 200, there may be numerous user authentication terminals and local user information storage devices and a very large number of payment devices carried by a like number of users. In some embodiments, the information dissemination system 200 may effectively include some or all components of a payment card account system, such as that described above in connection with FIG. 1

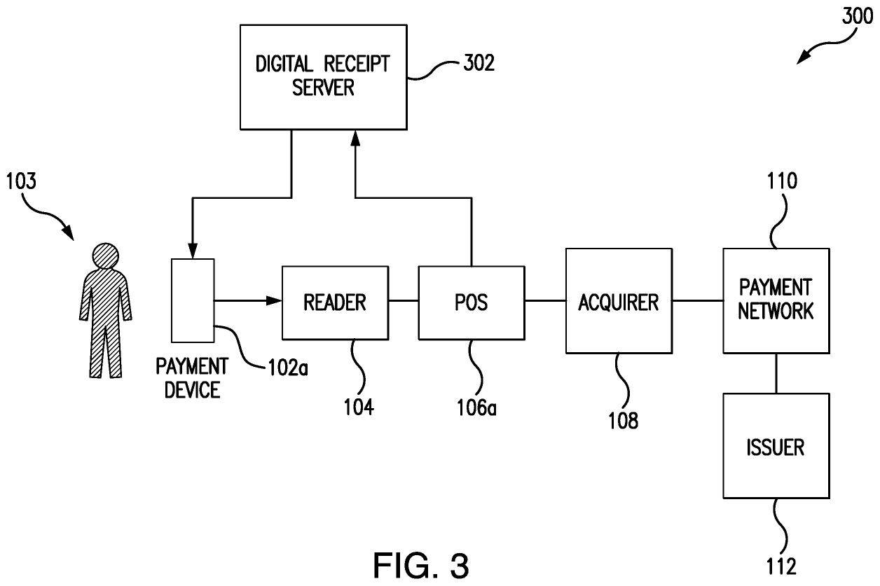

FIG. 3 is a block diagram of a payment system 300 that also has information dissemination functionality according to aspects of the present disclosure.

The payment system 300 may facilitate automatic electronic transaction receipt issuance to users from the point of sale. The payment system 300 may include all the components described above in connection with FIG. 1, but with the POS terminal referenced with “106a” to reflect enhanced capabilities relative to a conventional POS terminal, and with the payment device (assumed to be a payment-enabled smartphone) referenced with “102a” to reflect enhanced capabilities relative to a conventional payment-enabled mobile device.

The payment system 300 may also include a digital receipt server 302, which plays a central role in the digital receipting functionality.

To briefly describe operation of the payment system 300, after the transaction is initiated via the payment device 102a , the POS terminal 106a generates and transmits what may be a conventional transaction authorization request message. Assuming that a favorable authorization response is returned to the POS terminal 106a from the issuer computer 112, then the POS terminal 106a may transmit a receipt issuance request to the digital receipt server 302. The request may include the user's payment account number/token as well as transaction information of a kind typically included in a payment card account transaction receipt. The digital receipt server 302 may receive the request and then look up the data record for the user, to retrieve the user's email address/payment app ID. With the retrieved addressing information, the digital receipt server 302 may transmit a suitable digital/electronic transaction receipt to the payment device 102a , in addition to or in lieu of a paper receipt.

It is to be noted that the above-assumed favorable authorization response may occur only after the issuer computer 112 verifies a cryptogram that was generated and provided by the payment device 102 at the point of sale and in accordance with conventional practices.

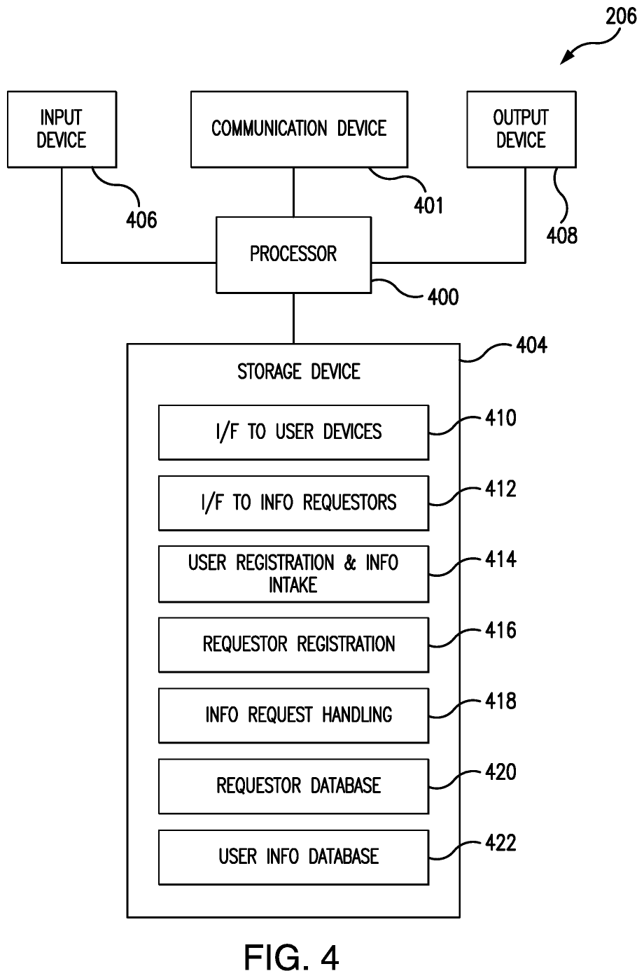

FIG. 4 is a block diagram that illustrates an example embodiment of the remote user information server computer 206 shown in FIG. 2.

Referring now to FIG. 4, the user information server computer 206 may, in its hardware aspects, resemble a typical server computer, but may be controlled by software to cause it to function as described herein.

The user information server computer 206 may include a computer processor 400 operatively coupled to a communication device 401, a storage device 404, an input device 406 and an output device 408. The communications device 401, the storage device 404, the input device 406 and the output device 408 may all be in communication with the processor 400.

The computer processor 400 may be constituted by one or more processors. Processor 400 operates to execute processor-executable steps, contained in program instructions described below, so as to control the user information server computer 206 to provide desired functionality.

Communication device 401 may be used to facilitate communication with, for example, other devices (such as numerous authentication terminals). Communication device 401 may comprise numerous communication ports (not separately shown), to allow the user information server computer 206 to communicate simultaneously with numerous other devices, including communications as required to simultaneously handle numerous information requests.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the user information server computer 206, executed by the processor 400 to cause the user information server computer 206 to function as described herein.

The programs may include one or more conventional operating systems (not shown) that control the processor 400 so as to manage and coordinate activities and sharing of resources in the user information server computer 206, and to serve as a host for application programs (described below) that run on the user information server computer 206.

In addition, the storage device 404 may store a software interface 410 that facilitates communication by the user information server computer 206 with user devices. Also, the storage device 404 may store a software interface 412 that facilitates communication by the user information server computer 206 with user authentication terminals and like devices operated by entities that request user information from the user information server computer 206.

Still further, the storage device 404 may store a user registration application program 414. The user registration application program 414 may control the processor 400 so as to enable the user information server computer 206 to receive input from users (e.g., via a website hosted by the user information server computer 206) to register the users with the user information server computer 206 and to allow the users to enter into the user information server computer 206 user information to be stored by the user information server computer 206 and disseminated to information requestors by the user information server computer 206.

Moreover, the storage device 404 may store an information requestor registration application program 416. The information requestor registration application program 416 may control the processor 400 so as to enable the user information server computer 206 to receive input from prospective information requestors (e.g., via a website hosted by the user information server computer 206) to register the information requestors with the user information server computer 206. The information requestor registration process may include storing the information requestor's public data encryption key in a data record for the information requestor in the user information server computer 206.

Further, the storage device 404 may store an information request handling application program 418. The information request handling application program 418 may control the processor 400 so as to enable the user information server computer 206 to handle information requests of the kind illustrated, for example, in FIG. 2 and described in conjunction with FIG. 2.

The storage device 404 may also store, and the user information server computer 206 may also execute, other programs, which are not shown. For example, such programs may include a reporting application, which may respond to requests from system administrators for reports on the activities performed by the user information server computer 206. The other programs may also include, e.g., one or more website hosting programs, device drivers, database management programs, communications software, etc.

The storage device 404 may also store an information requestor database 420 and a user database 422. The information requestor database 420 may store data entries that correspond to information requestors that have registered with the user information server computer 206. The user database 422 may store data entries that correspond to users who have registered with the user information server computer 206; the entries in the user database 422 may store user information to be disseminated by the user information server computer 206 in response to information requests, as described herein.

The storage device 404 may also store one or more other databases (not separately indicated) required for operation of the user information server computer 206.

It should be noted that other computer components of information dissemination system 200, as shown in FIG. 2, may be similar in their hardware architecture and components to the user information server computer 206 depicted in FIG. 4. Further, at least some of the blocks shown in FIG. 3 may be considered to represent both a respective entity and a computer system operated by the respective entity. Each such computer system may be similar in its hardware architecture and components to the user information server computer 206 depicted in FIG. 4.

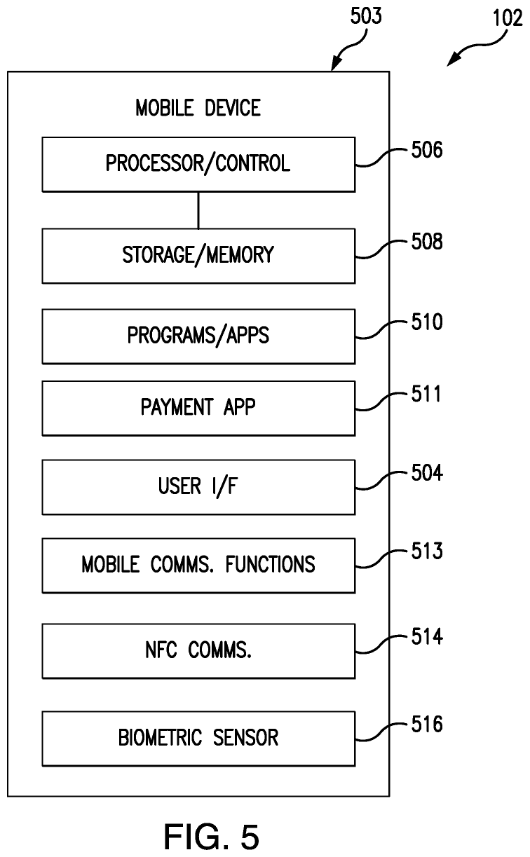

Some details of one example of the payment device 102 will be described below in conjunction with FIG. 5, with the assumption that the payment device is a suitably programmed smartphone. As will be recounted in use cases described below, other types of payment devices may be employed in other use cases, and such other types of payment devices may include, for example, an IC (integrated circuit) payment card in the familiar ID-1 format.

Referring now to FIG. 5, the payment device 102 (according to this example) may include a housing 503. In many embodiments, the front of the housing 503 is predominantly constituted by a touchscreen (not separately shown), which is a key element of the user interface 504 of the payment device 102.

The payment device 102 further includes a mobile processor/control circuit 506, which is contained within the housing 503. Also included in the payment device 102 is a storage/memory device or devices (reference numeral 508). The storage/memory devices 508 are in communication with the processor/control circuit 506 and may contain program instructions to control the processor/control circuit 506 to manage and perform various functions of the payment device 102. As is well-known, a device such as payment device 102 may function as what is in effect a pocket-sized personal computer (under the assumption that the payment device 102 is embodied as a smartphone), via programming with a number of application programs, or “apps”, as well as a mobile operating system (OS). (The apps are represented at block 510 in FIG. 5, and may, along with other programs, in practice be stored in block 508, to program the processor/control circuit 506.)

Also shown in FIG. 5 is a payment app 511. The payment app 511 is shown apart from the other apps represented at block 510, in part due to the particular relevance of the payment app 511 to functionality ascribed herein to the payment device 102. The payment app 511 may be provided in accordance with known practices and may enable the payment device 102 to engage in null-amount transactions, such as a transaction recounted in a use case described above; the payment app 511 may also enable the payment device 102 to engage in purchase transactions (i.e., transactions involving a non-zero transaction amount).

In some embodiments, the payment app 511 and/or payment account data may be stored in a secure element (SE—not shown apart from block 508), which may be provided in some embodiments of the payment device 102 to provide enhanced security for the payment app 511 and/or sensitive data associated therewith. The SE, if present, may be conventional in its hardware aspects. In addition or alternatively, security for the payment app 511 may be enhanced by known alternatives to an SE, such as a TEE (trusted execution environment).

To the extent that the SE includes processing capabilities, it may functionally (though likely not physically) overlap with block 506; to the extent that the SE includes storage (and particularly program storage) capabilities, it may functionally (though likely not physically) overlap with block 508.

As is typical for mobile devices, the payment device 102 may include mobile communications functions as represented by block 513. The mobile communications functions may include voice and data communications via a mobile communication network (not shown) with which the payment device 102 is registered.

In addition, to permit the payment device 102 to emulate a contactless payment card, the payment device 102 may include short-range radio communications capabilities (block 514), including for example NFC (near field communication). Thus block 514 may represent a suitable antenna (not separately shown) that is appropriate for NFC communications with a POS terminal reader component as well as driving and receiving circuitry associated with the antenna. It will be appreciated that the NFC antenna may be separate and different from the antenna (not separately shown) utilized by the payment device 102 for the mobile communication functions represented by block 513.

Also shown in FIG. 5 is a biometric sensor 516, which may be one of the components of the payment device 102. The biometric sensor 516 may be, for example, a fingerprint sensor, and may operate to assist in verifying the user of the device in connection with transactions initiated using the payment device 102.

From the foregoing discussion, it will be appreciated that the blocks depicted in FIG. 5 as components of the payment device 102 may in effect overlap with each other, and/or there may be functional connections among the blocks which are not explicitly shown in the drawing. It may also be assumed that, like a typical smartphone, the payment device 102 may include a rechargeable battery (not shown) that is contained within the housing 503 and that provides electrical power to the active components of the payment device 102.

It has been posited that the payment device 102 may be embodied as a smartphone, but this assumption is not intended to be limiting, as payment device 102 may alternatively, in at least some cases, be constituted by a tablet computer, a smartwatch or by other types of portable electronic devices, or by an IC payment card.

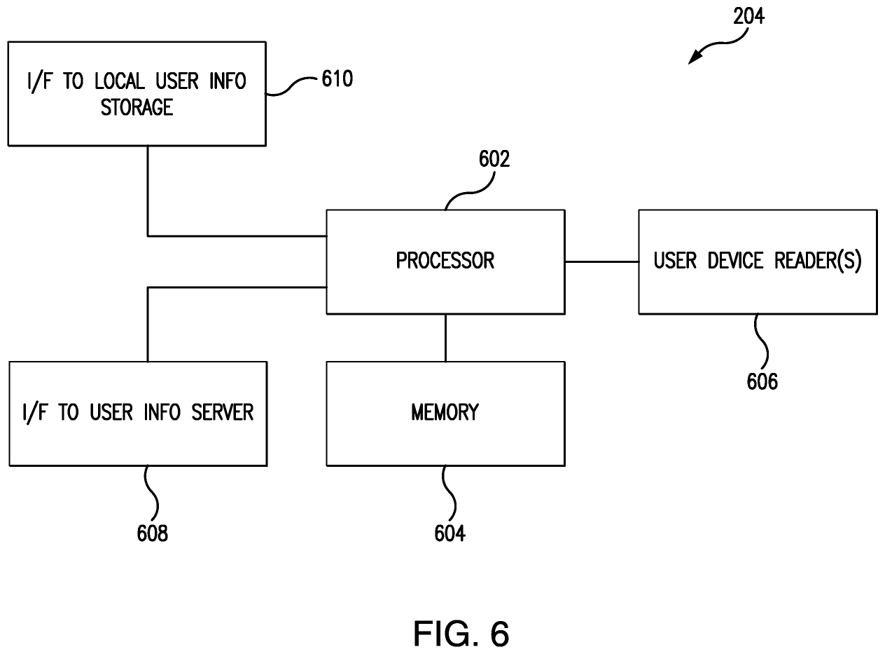

FIG. 6 is a simplified block diagram of an example embodiment of the user authentication terminal 204 shown in FIG. 2. In some embodiments, the user authentication terminal 204 may be a modified POS terminal or may be constructed as a subset of a POS terminal with additional functionality as described herein.

The user authentication terminal 204 may include a processor 602. The processor 602 may be of a type described above in relation to component 400 (FIG. 4) of the user information server computer 206. Continuing to refer to FIG. 6, the user authentication terminal 204 may also include a memory device 604. The memory device 604 may be in communication with the processor 602 and may store program instructions for controlling the processor 602. The memory device 604 may resemble component 404 of user information server computer 206, as described above in connection with FIG. 4.

Continuing to refer to FIG. 6, the user authentication terminal 204 may further include one or more user device readers 606. The device reader(s) 606 may be constructed according to conventional practices so as to be suitable for reading the types of payment devices referred to herein.

The user authentication terminal 204 may further include a communication interface 608 for permitting the user authentication terminal 204 to engage in data communications with the user information server computer 206. The communication interface 608 may be coupled to and controlled by the processor 602.

The user authentication terminal 204 may also include a communication interface 610 for permitting the user authentication terminal 204 to transfer user information for storage in the local user information storage device 208. The communication interface 610 may be coupled to and controlled by the processor 602.

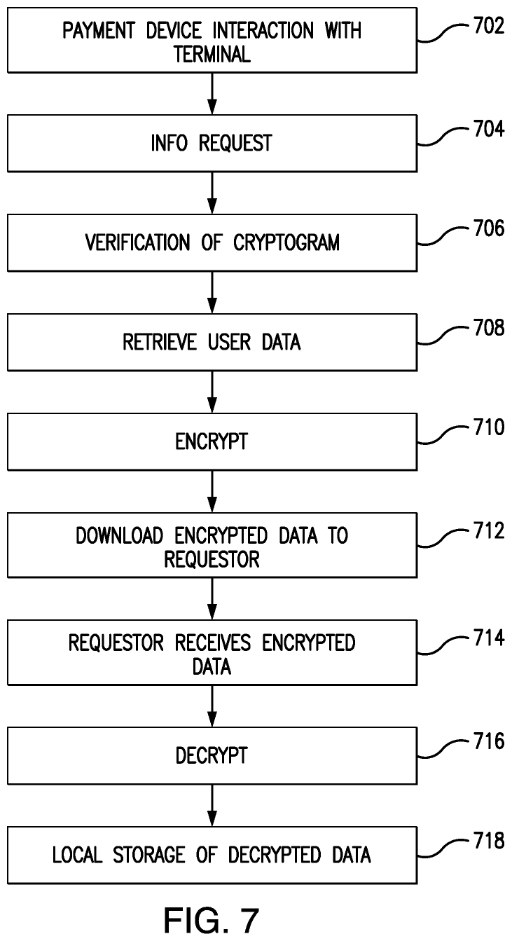

FIG. 7 is a flow chart that illustrates a process that may be performed according to aspects of the present disclosure in the information dissemination system 200. The ensuing discussion of FIG. 7 assumes that the user has previously registered with and stored information on the user information server computer 206. In may have been the case that the user's identity was verified by the user information server computer 206 as part of the registration process. For example, the user information server computer 206 may have sent a one-time code to a mobile device known to be associated to the user, and the user may have input that code to the user information server computer 206 to authenticate himself/herself. The information supplied to the user information server computer 206 by the user may include a payment account number or payment token that will be used by the user information server computer 206 to recognize that future information requests pertain to the user. The payment account number or payment token may represent a payment card system account that has been issued to the user by an account issuer.

It may also be assumed that the information requestor has previously been registered with the user information server computer 206, with suitable steps having been taken to establish trust between the information requestor and the user information server computer 206. As part of the registration, the information requestor may have supplied to the user information server computer 206 the information requestor's public encryption key. The public encryption key supplied may be part of a public-private key pair, with the information requestor holding secure from disclosure the private key of the pair.

Referring now to FIG. 7, at block 702 the user may present a payment device for interaction with the information requestor's user authentication terminal. The interaction may entail a null-amount transaction according to a transaction protocol used in payment card account system transactions. The protocol may, for example, be a standard EMV transaction protocol. (As is well known to those who are skilled in the art, “EMV” derives from “Europay-Mastercard-Visa”, a reference to three entities that originally established the standard for this protocol.) Other protocols that may be used may include DSRP (digital remote secure payment) or “3D Secure”. Both of these protocols are well known to those who are skilled in the art.

As part of the interaction, the payment device may be read by the authentication terminal via short range radio communication or (where the payment device is a contact payment IC card), via direct conductive data communication channel established between the authentication terminal and the payment device. As a further alternative, the payment device may display a QR (quick response) code or the like to be read by the authentication terminal and the authentication terminal may scan the QR code to receive data contained in the QR code.

The data communicated from the payment device to the authentication terminal may include a payment account number or payment token that represents a payment card system account that has been issued to the user. The null-amount transaction may be said to be “based on” such payment account number or payment token. The data communicated from the payment device to the authentication terminal may further include a cryptogram generated by the payment device for the transaction in accordance with the transaction protocol that governs the null amount transaction.

At block 704, the authentication terminal generates and transmits an information request to the user information server computer 206. The information request may include data generated and/or exchanged during the null-amount transaction performed by the authentication terminal with the user's payment device. The data included in the information request may encompass the user's payment account number/token and the cryptogram generated for the null-amount transaction by the payment device. It may be assumed that the user information server computer 206 receives the information request as generated and transmitted by the authentication terminal.

At block 706, the user information server computer 206 may verify the cryptogram. This may be done, for example, in accordance with known practices for verifying cryptograms by account issuers in payment card account system transactions. This may occur, for example, after the user information server computer 206 has verified the bona fides of the information requestor and has identified the user via the payment account number/token included in the information request. Based on the identity of the information requestor, the user information server computer 206 may refer to a data entry that indicates a standard list of types of information that the information requestor wishes to receive. The user information server computer 206 may compare this list with a list of the types of information that the user has authorized to be disseminated to information requestors of the type of the requestor. (It will be understood, for example, that the user may have authorized one list of information types for release to health care providers, and a different list to retail merchants, and so forth.) To the extent that the two lists of information types intersect, the user information server computer 206 may retrieve (block 708) the particular information for the user (of the common information types) that has previously been stored by the user with the user information server computer 206.

To divert for the moment to a specific use-case, if the information requestor is a hospital, the retrieved information may include the user's name, contact information, date of birth, identity of health insurer and the user's health insurance identification number, among other items typically sought or required during patient check-in to a hospital. More extensive data downloads, including downloading of medical records, are also within the contemplation of this example.

At block 710, the user information server computer 206 may encrypt the retrieved user information using the information requestor's public encryption key that has previously been provided to the user information server computer 206 by the information requestor. The user information server computer 206 may also digitally sign the retrieved data to provide authentication that the data does in fact originate from the user information server computer 206, which may be regarded as a trusted source by the information requestor.

At block 712, the user information server computer 206 downloads/transmits the encrypted user information to the information requestor (e.g. to the authentication terminal). At block 714, the information requestor/authentication terminal receives the downloaded user information. At block 716, the information requestor decrypts the encrypted user information using the information requestor's private key. At block 718, the information requestor attends to local storage of the decrypted user information. The storage of the user information by the information requestor may be physically local (e.g., in a data storage device co-located with the authentication terminal), or may be “logically local”—e.g., in a cloud-based storage facility that is readily accessible by the information requestor. In either case, the user information is now available for the information requestor to use as relevant or helpful to the information requestor's relationship with the user.

With arrangements as described in connection with FIGS. 2 and 7, security features employed in payment card account system transaction may be usefully adapted to secure and control dissemination of user information from a central source to trusted information requestors who have engaged or are engaging in interaction with a registered user. This adaptation of payment card account system security practices to additional uses may reflect the supposition—often valid—that security measures adequate for a payment card account system transaction may also be satisfactory to secure dissemination of user's personal information from a trusted central source. With this type of information dissemination system, introduction (or re-introduction) of users to other parties may be streamlined and made more convenient and less prone to errors. For example, this type of information dissemination system may reduce or eliminate the hand-writing and/or manual keyboarding of at least some of the user's information when the user is coming into contact with a party that needs or wishes to have certain types of information about the user.

In some variations on the process of FIG. 7, the user information server computer 206—in response to receiving the information request—and perhaps after verifying the cryptogram and/or retrieving the user information, may communicate with the user to confirm that the user consents to the information download. This may occur prior to the user information server computer 206 actually proceeding with the information download. Where the communication from the user information server computer 206 to the user is via the user's mobile device (which may also be the payment device), the resulting delay in complying with the information request may be quite brief.

In some embodiments, there may be various levels of security required for downloading of different types of information. For instance, for downloading of health insurance information, a full cryptogram and verification thereof may be required. On the other hand, for downloading of less sensitive information, such as the user's name and contact information, a less secure form of security data, such as an unpredictable and verifiable code, may suffice.

In the embodiments of FIGS. 2 and 3, an entity other than the user's payment card account issuer is the recipient of the information request and is the source of information. In other embodiments, however, the information request may resemble or actually be a transaction authorization request message and may be handled by the account issuer. Depending on the type/volume of information to be downloaded to the information requestor/merchant, the information may be downloaded within one or more auxiliary data fields in the issuer's transaction authorization response message or via a separate channel, such as a suitable API (application program interface). In some embodiments, even when the issuer is the information source, the information request may be transmitted to the issuer via an API separate from the usual payment card account system “rails”.

In some use cases, the information may be requested by a merchant and may include loyalty account information, such as the user's loyalty account number. In addition or alternatively, information requested by a merchant may include information useful in serving the user as a customer, such as clothing sizes, user preferences, etc.

In the embodiment of FIG. 2, the authentication terminal is utilized to obtain user information. However, in other embodiments, the authentication terminal may be embodied as a physical access control device, such as an electronic lock that controls access to a physical location or space, such as a room or a building, and the payment device may serve as an electronic key. The user information server computer 206 may be replaced in such embodiments with a remote access control server (not shown apart from block 206). The remote access control server may verify the cryptogram, and upon doing so, may trigger the authentication terminal to grant access to the space or location in question.

In some embodiments user information server computer 206 may be operated by an entity associated with the operator of a payment card account system, or may be at least partially integrated with a digital enablement service provided by such a payment system operator.

The automated user authentication and release of information in response to a payment account system transaction provides the technical effect of reducing or avoiding errors in manual data entry into computer devices.

A transaction is to be deemed a “payment account system transaction”, even if not communicated to a payment system, so long as the transaction is initiated using a payment card or payment device and/or a payment application used for initiating transactions in payment systems.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, a “server” includes a computer device or system that responds to numerous requests for service from other devices.

As used herein and in the appended claims, the term “memory” should be understood to encompass a single memory or storage device or two or more memories or storage devices.

The above descriptions and illustrations of processes herein should not be considered to imply a fixed order for performing the process steps. Rather, the process steps may be performed in any order that is practicable, including simultaneous performance of at least some steps and/or omission of some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” and “payment account number” are used interchangeably and include a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system”, “payment card account system” and “payment account system” are used interchangeably and refer to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
performing a null-amount payment account system transaction in cooperation with a user payment device presented by a user; and
in response to successful completion of said null-amount transaction, receiving a download of data regarding said user.

2. The method of claim 1, wherein the downloaded data includes insurance information applicable to the user.

3. The method of claim 1, wherein the downloaded data includes contact information applicable to the user.

4. The method of claim 1, wherein said transaction includes the user payment device generating and transmitting a transaction cryptogram.

5. The method of claim 1, wherein the transaction is an EMV transaction.

6. The method of claim 1, wherein the transaction is based on a payment token or payment account number stored in or accessed by the user payment device, the payment token or payment account number representing a payment system account previously issued to the user.

7. The method of claim 6, wherein said data is received from an issuer of the payment system account.

8. The method of claim 6, wherein said data is received from an entity other than an issuer of the payment system account.

9. The method of claim 1, wherein the user payment device is a payment-enabled mobile device.

10. The method of claim 1, wherein the user payment device is an integrated circuit payment card.

11. A method comprising:
receiving a payment account system transaction request, the request including authentication data;
verifying the authentication data; and
in response to a result of the verifying step, downloading user information to an originator of the request.

12. The method of claim 11, wherein the transaction request is for a null-amount transaction.

13. The method of claim 12, wherein the user information includes insurance information related to a user who has interacted with the originator of the request.

14. The method of claim 11, wherein the user information includes insurance information related to a user who has interacted with the originator of the request.

15. The method of claim 11, wherein the transaction request is received in connection with a purchase from the originator of the request.

16. The method of claim 15, wherein the user information includes contact information for a user who is making the purchase.

17. The method of claim 16, wherein the contact information includes the user's email address.

18. A method comprising:
performing a null-amount payment account system transaction in cooperation with a user payment device presented by a user; and
in response to successful completion of said null-amount transaction, granting to the user access to a physical space.

19. The method of claim 18, wherein said transaction includes the user payment device generating and transmitting a transaction cryptogram.

20. The method of claim 19, wherein the transaction is an EMV transaction.
